(19) United States
(12) Patent Application Publication
(10) Pub. No.: US 2010/0235961 A1
(43) Pub. Date: Sep. 23, 2010

(54) METHOD OF MANUFACTURING A STRETCHABLE FILAMENT

(76) Inventor: Miles Stephen Cain, Derbyshire (GB)

Correspondence Address: MORGAN LEWIS & BOCKIUS LLP, 1111 PENNSYLVANIA AVENUE NW, WASHINGTON, DC, 20004, US

(21) Appl. No.: 12/598,668

(22) PCT Filed: May 2, 2008
(86) PCT No.: PCT/GB2008/001564

§ 371 Date: May 3, 2010

(30) Foreign Application Priority Data
May 3, 2007 (GB) 0708527.7
Dec. 31, 2007 (GB) 0725366.9

(51) Int. Cl. A41D 1/00; B29C 35/08; D04B 11/12; D03D 15/08

(52) U.S. Cl. 2/69; 264/477; 425/174.4; 66/202; 139/421

(57) ABSTRACT

A method of manufacturing a stretchable filament of silicone elastomer (10) comprising the steps of extruding a length of uncured silicone elastomer (10) and curing the uncured silicone elastomer (10) or allowing the uncured silicone elastomer (10) to cure to form a solid filament.

The invention relates particularly, but not exclusively, to a method of manufacturing a stretchable filament of silicone elastomer, which may be incorporated into the knitting or weaving process of a textile article in order to provide stretch in the textile article.

Conventionally synthetic fibres such as elastane have been used in the manufacture of stretchable garments. While elastane exhibits exceptional elasticity, it is particularly sensitive to heat and prone to break when exposed to temperatures above a relatively low threshold. This sensitivity to heat therefore limits temperatures to which garments containing elastane can be exposed.

In addition to its sensitivity to heat, elastane is a copolymer of polyurethane and polyethylene glycol and is therefore based on petrochemicals. Consequently, due to the global shortage of petrochemicals the expense of producing elastane is increasing.

Other stretchable materials such as natural rubber and polyurethane produce poor alternatives to elastane. Natural rubber for example ages poorly, becoming brittle and hard with age, and polyurethane is a thermoplastic elastomer that has a tendency to be rigid when cold and produces undesirable stretch when heated.

According to a first aspect of the invention there is provided a method of manufacturing a stretchable filament of silicone elastomer comprising the steps of:
extruding a length of uncured silicone elastomer; and
curing the uncured silicone elastomer or allowing the uncured silicone elastomer to cure to form a solid filament.

The use of a silicone elastomer obviates the problems outlined above because, once cured, it produces a filament having a high rate of recovery following stretch and its performance is not affected by temperature.

The uncured silicone elastomer preferably requires a trigger to initiate curing and thereby ensure that the elastomer does not start to cure until it is exposed to certain conditions. This provides a means for controlling commencement of the curing process and, in turn, allows a user to ensure the elastomer does not cure until after it is extruded.

In one embodiment the trigger may require that the uncured silicone elastomer is heated to a specific temperature before it will begin to cure.

In another embodiment the uncured silicone elastomer may be in multi-part form and curing of the silicone elastomer may be triggered by mixing of the respective mixable parts immediately prior to, or during, extrusion of the uncured silicone elastomer.

In a particularly preferred embodiment the uncured silicone elastomer requires UV radiation to trigger curing thereof and the method further includes the step of exposing the uncured silicone elastomer to UV radiation following extrusion to initiate curing thereof.

The use of an uncured silicone elastomer requiring UV radiation to trigger curing ensures the elastomer does not start to cure until it is exposed to UV radiation and thereby provides a means for controlling commencement of the curing process. This in turn allows a user to ensure the elastomer does not cure until after it is extruded.

The uncured silicone elastomer may be in the form of a liquid or a paste but is most preferably in the form of a liquid.

In embodiments where curing of the uncured silicone elastomer is triggered by heating the uncured silicone to a specific temperature the time taken to heat the uncured silicone elastomer to the trigger temperature may be accelerated by heating the uncured silicone elastomer prior to the step of extruding the uncured silicone elastomer.

In such embodiments it is of course important that any pre-heating is limited to ensure that curing of the silicone elastomer is not initiated before the silicone elastomer is extruded.

Once curing is initiated, the uncured silicone elastomer may be allowed to cure under ambient conditions. A relatively high rate of cure is however desirable to ensure that curing of the uncured silicone elastomer is completed as soon as possible following extrusion.

The rate of curing of an uncured silicone elastomer may be increased through the application of heat, the more heat energy that is applied to the elastomer within a period of time the greater the rate of curing. Conventionally ovens have been used to supply sufficiently large quantities of heat energy in order to accelerate the rate of curing.

In embodiments where a trigger is required to initiate curing of the uncured silicone elastomer, the rate of curing of the uncured silicone elastomer may be increased without the need for an oven by heating the uncured silicone elastomer or mixable parts of the uncured silicone elastomer prior to extrusion. Pre-heating the uncured silicone elastomer or the mixable parts of the uncured silicone elastomer accelerates the curing of the uncured silicone elastomer once curing is initiated and thereby allows a user to achieve a higher rate of cure than would otherwise be achieved unless the uncured silicone elastomer was heated following application of the uncured silicone elastomer.

As outlined above, in embodiments where curing of the uncured silicone elastomer is triggered by heating the uncured silicone to a specific temperature it is of course important that any pre-heating is limited to ensure that curing of the silicone elastomer is not initiated before the silicone elastomer is extruded.

The use of an uncured silicone elastomer requiring UV radiation to trigger curing, or an uncured silicone elastomer in multi-part form that does not cure until mixed, allows for pre-heating of the elastomer since it ensures that the elastomer does not start to cure until after it is extruded.

Regardless of the nature of the uncured silicone elastomer, the rate of curing may be increased by applying heat to the uncured silicone elastomer during curing by means of heated elements such as, for example, heated plates, heated rollers or heat lamps.

Preferably curing of the uncured silicone elastomer is completed within five seconds; is more preferably completed with two seconds; and is most preferably completed within one second.

The method according to the invention may involve the use of an uncured silicone elastomer constituted from two or more mixable parts so as to permit variance of the physical properties of the elastomer following its extrusion and curing thereof.

This allows a user to impart desirable physical characteristics, such as a particular elastic modulus or a particular friction generating quality to the silicone elastomer following curing.

The relative proportions of the respective mixable parts of the uncured silicone elastomer may be chosen immediately prior to the step of extruding the uncured silicone elastomer so as to impart desirable physical properties to the silicone elastomer following curing.

In such embodiments, the relative proportions of the respective mixable parts of the uncured silicone elastomer may be varied during the step of extruding the uncured silicone elastomer so as to impart varying physical properties to the length of silicone elastomer following the step of curing the uncured silicone elastomer.

This allows the creation of a continuous region of cured elastomer in which one area has, for example, a different modulus of elasticity to areas immediately adjacent thereto.

In order to produce filaments having different characteristics when woven or knit into garments, the uncured silicone elastomer may be extruded via an extrusion nozzle having a manifold that is changeable to create filaments having different cross-sectional shapes. For example, the manifold of the extrusion nozzle may be chosen such that the resultant solid filament has an oval, round or dumbbell cross-sectional shape. The manifold may also be chosen such that the resultant solid filament has a smooth or textured surface.

As well as varying the shape and/or size of the extrusion nozzle manifold, the cross-sectional area and/or the cross-sectional shape of the resultant filament may be varied by varying the rate of extrusion of the uncured silicone elastomer.

The cross-sectional area and/or the cross-sectional shape may also be varied by varying the position downstream of the extrusion head at which curing is initiated. For example, the greater the distance downstream from the extrusion head that curing is initiated, the greater the effect gravity will have on the extruded elastomer prior to curing and therefore the smaller the cross-sectional area of the filament following curing.

In yet further embodiments, the cross-sectional size and/or shape of the uncured silicone elastomer may be varied by directing one or more jets of air at the uncured silicone elastomer following extrusion and before completion of curing.

While the uncured silicone elastomer is preferably cured under the influence of gravity following extrusion, in other embodiments the uncured silicone elastomer may be extruded onto an impenetrable substrate, the impenetrable substrate forming a support for the uncured silicone elastomer following extrusion and prior to curing thereof. In such embodiments the method further includes the step of removing the silicone elastomer from the substrate following the step of curing the uncured silicone elastomer to form a solid filament. It is thus important that any such substrate is impenetrable to the uncured silicone elastomer to allow removal of the silicone elastomer from the substrate following curing thereof without resulting in tearing or ripping of the silicone elastomer.

In order to control the cross-sectional shape of the resultant filament, the impenetrable substrate may define a mould cavity to receive the uncured silicone elastomer.

In embodiments in which the uncured silicone elastomer is extruded onto an impenetrable substrate the cross-sectional area of the resultant filament is of course dependent on the rate of relative movement between an extrusion outlet and the impenetrable substrate onto which the uncured silicone elastomer is extruded as well as the rate of extrusion of the uncured silicone elastomer.

In order to produce multi-filament yarns, uncured silicone elastomer extruded from neighbouring extrusion nozzles may be combined during curing of the strands of elastomer. Intermingling of the strands during curing results in the strands adhering to each other so as to produce a multi-filament yarn on completion of the curing process.

In such embodiments where the strands of uncured silicone elastomer are cured under the influence of gravity, one or more air jets may be used to improve mixing and/or intermingling of the strands during curing to produce the multi-filament yarn.

According to a second aspect of the invention there is provided an apparatus for manufacturing a stretchable filament of silicone elastomer in the form of an elastomer requiring UV radiation to trigger curing thereof comprising:
an applicator to extrude a length of uncured silicone elastomer, the applicator including a darkened supply passage to prevent irradiation of the uncured silicone elastomer to UV radiation prior to extrusion of the uncured silicone elastomer; and
a UV light source to irradiate the uncured silicone elastomer following extrusion of the uncured silicone elastomer to trigger curing of the uncured silicone elastomer.

So as to increase the rate of curing of the uncured silicone elastomer after its exposure to UV radiation, the apparatus may further include one or more heat sources to heat the uncured silicone elastomer upstream of the applicator and/or downstream of the UV light source.

The nature and combination of heat sources are preferably determined by the rate of curing required.

The applicator preferably includes an extrusion nozzle having a manifold defining a 1 mm diameter opening through which uncured silicone elastomer may be extruded.

In other embodiments the manifold may define an opening having a smaller or larger diameter depending on the desired cross-sectional size of the filament following curing.

In embodiments where a strand of uncured silicone elastomer is extruded from the applicator and cures under the influence of gravity, the apparatus may further include one or more air jets downstream of the applicator to direct jet(s) of air at the strand of uncured silicone elastomer in order to influence and thereby control the cross-sectional size of the eventual solid filament of silicone elastomer.

According to a third aspect of the invention there is provided a textile article incorporating yarns of silicone elastomer.

The incorporation of yarns of silicone elastomer imparts a degree of stretch to the textile article.

The textile article is preferably a knit or woven article, and the knit or weave is preferably chosen to expose the yarns of silicone elastomer on an outer surface of the textile article.

In embodiments where the woven or knit textile article is a garment, the knit or weave may be chosen to expose the silicone elastomer on an inner surface of the garment intended to be worn against a wearer's skin.

in the form of a pair of briefs, a brassiere or a hosiery leg.

Exposure of yarns of silicone elastomer is advantageous in that it increases the coefficient of friction of the garment at localized points on the surface of the garment and also allows the garment to benefit from the adhesive properties of the silicone elastomer yarns. This in turn means that when arranged against the skin of a wearer, the exposed silicone yarns serve to ensure that the garment remains in a desired position on the wearer's body. For example in embodiments where the garment is a medical stocking, the exposure of yarns of silicone elastomer on an inner surface of the stocking reduces the risk of the stocking slipping down a wearer's leg.

In other embodiments, the textile article may be an undergarment in the form of a pair of briefs, a brassiere or a hosiery leg.

Embodiments of the invention will now be described with reference to the accompanying drawings in which:

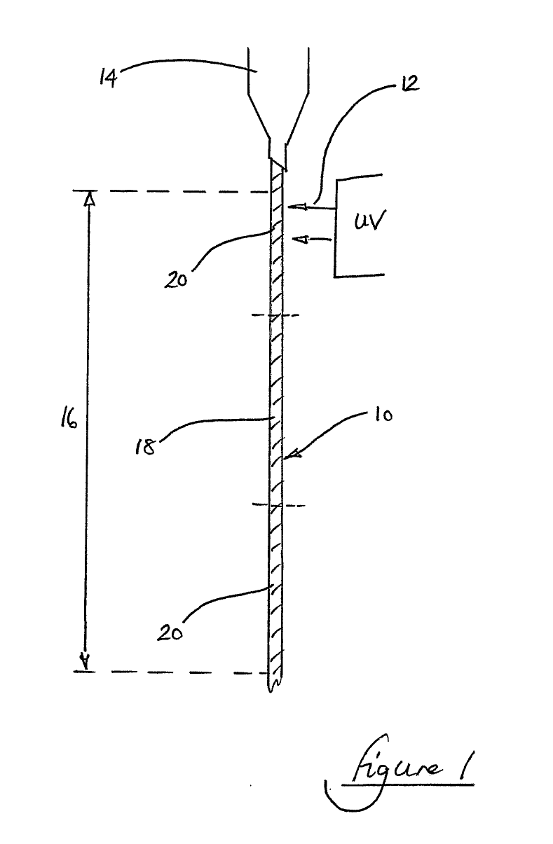

FIG. 1 illustrates steps of a method according to a first embodiment of the invention;

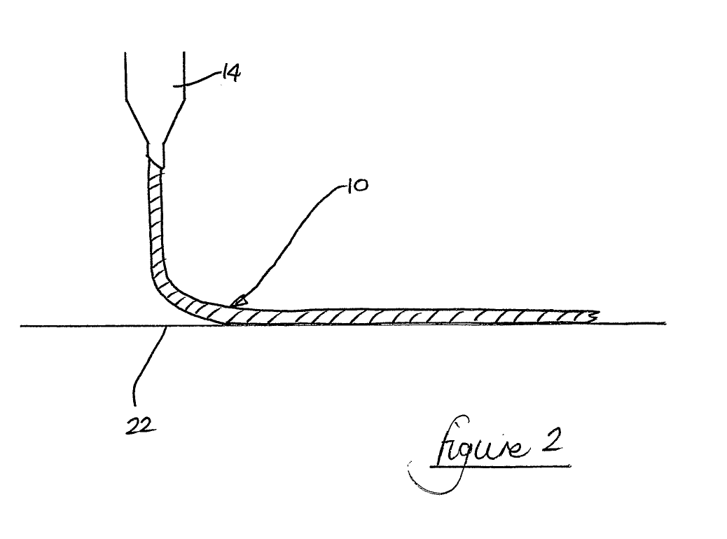

FIG. 2 illustrates the steps of a method according to a second embodiment of the invention;

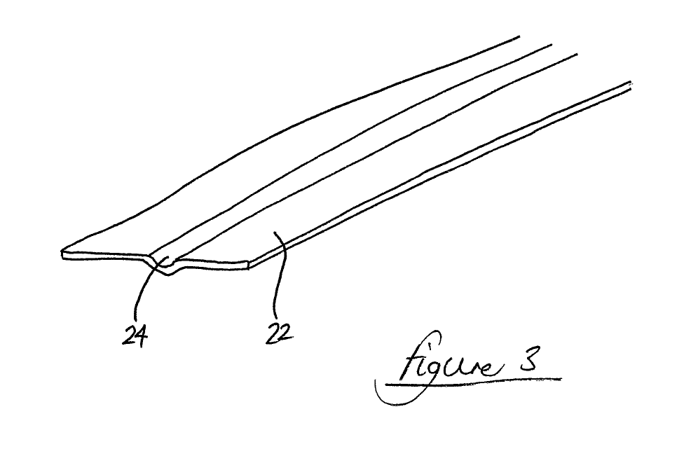

FIG. 3 illustrates the steps of a method according to a third embodiment of the invention; and

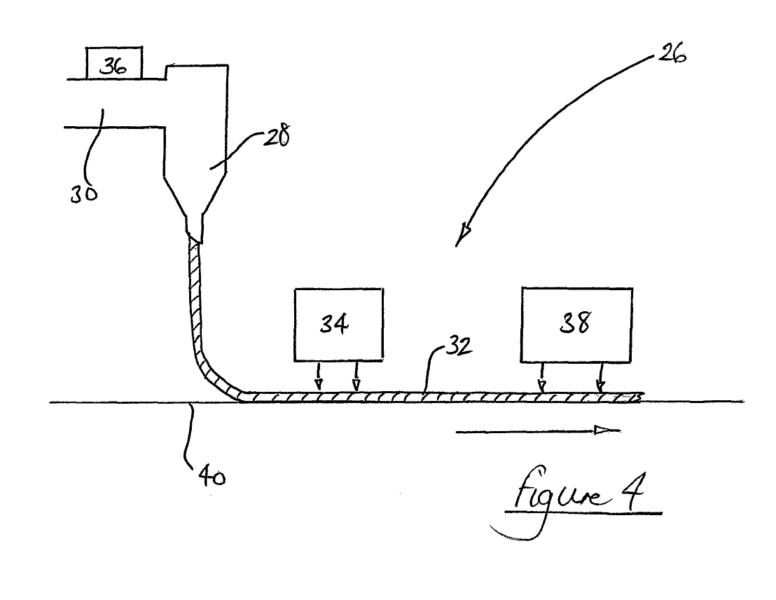

FIG. 4 shows a schematic representation of an apparatus according to a fourth embodiment of the invention.

A method of manufacturing a stretchable filament of silicone elastomer according to a first embodiment of the invention is shown in FIG. 1.

The method involves the step of extruding a length of uncured silicone elastomer 10 requiring UV radiation to trigger curing thereof.

Following extrusion of the uncured silicone elastomer 10, the uncured silicone elastomer 10 is exposed to UV radiation 12 to trigger curing of the uncured silicone elastomer 10. The uncured silicone elastomer 10 then cures to form a solid filament.

In this method curing of the silicone elastomer 10 occurs at ambient room temperature.

In other embodiments of the invention, the rate of curing of the silicone elastomer 10 may be increased by pre-heating the uncured silicone elastomer 10 prior to extrusion. Following exposure of the uncured silicone elastomer 10 with UV radiation, the heat present in the uncured silicone elastomer 10 accelerates the rate of curing thereof.

In further embodiments of the invention, the rate of curing of the silicone elastomer 10 may be increased by heating the silicone elastomer 10 following exposure of the uncured silicone elastomer 10 to UV radiation. Such heating may be performed by means of heat lamps and/or heated plates.

In yet further embodiments of the invention, the rate of curing of the silicone elastomer may be increased further by heating the silicone elastomer 10 both prior to its extrusion and following its exposure to UV radiation.

In the method shown in FIG. 1 the length of uncured silicone elastomer is extruded from an extrusion head 14 and is exposed to UV radiation whilst hanging from the extrusion head 14. In such embodiments the cross-sectional area of the length of the uncured silicone elastomer 10, and therefore the resultant filament following curing thereof, is controlled by controlling the rate of extrusion of the silicone elastomer 10 from the extrusion head 14.

The cross-sectional area and the cross-sectional shape of the length of the uncured silicone elastomer 10, and therefore the resultant filament following curing thereof, may also be varied by varying the shape and size of a manifold of the extrusion head 14.

By varying the shape and size of the manifold, the cross-sectional shape may be varied so as to produce solid filaments having a round, oval or dumbbell shape. By varying the shape of the manifold the outer surface of the resultant filament may also be varied. For example filaments having smooth, rough or combination surfaces may be produced.

It is envisaged that filaments having rough surfaces may be advantageous in preventing run-back in frayed edges of fabrics incorporating such filaments.

So as to vary the physical properties of the silicone elastomer 10 following curing thereof, the uncured silicone 10 is preferably formed from two parts. This allows, for example, the modulus of elasticity of the resultant filament to be varied.

It is envisaged that in other embodiments the uncured silicone elastomer 10 may be formed from one part or more than two parts.

In a particularly preferred embodiment of the invention, the relative proportions of the respective mixable parts of the uncured silicone elastomer 10 are chosen immediately prior to the step of extruding the uncured silicone elastomer 10 depending on the desired physical characteristics of the silicone elastomer 10 following curing.

The relative proportions of the respective mixable parts are preferably variable during the step of extruding the uncured silicone elastomer 10 so as to impart varying physical properties to the silicone elastomer 10 once it is cured. This allows the creation of a continuous region 16 of silicone elastomer 10 in which discrete regions 18 having a higher modulus of elasticity to regions 20 located either side thereof.

While the method of manufacture illustrate in FIG. 1 involves allowing a length of uncured silicone elastomer 10 to hang from an extrusion head 14 whilst it is exposed to UV radiation and cured or allowed to cure, in other embodiments of the invention a length of uncured silicone elastomer 10 may be extruded onto an impenetrable substrate 22, as shown in FIG. 2. In this embodiment, the impenetrable substrate 22 acts to support the uncured silicone elastomer 10 whilst it is exposed to UV radiation and then cured.

It is important that the substrate 22 is impenetrable to the uncured silicone elastomer 10 since the silicone elastomer 10 is then prevented from bonding with the substrate during the step of curing. This ensures that the resultant filament may be removed from the substrate following curing without tearing or ripping of the cured silicone elastomer.

In such embodiments, relative movement between the impenetrable substrate 22 and the extrusion head 14 is required to allow a length of the uncured silicone elastomer 10 to be laid onto the substrate 22. The rate at which the substrate 22 moves relative to the extrusion head 14 together with the rate at which the uncured silicone elastomer 10 is extruded from the extrusion head 14 may be used to control the cross-sectional size of the extruded length of uncured silicone elastomer 10, and therefore the cross-sectional size of the filament following curing.

In order to further control the cross-sectional shape of the extruded length of uncured silicone elastomer 10, the impenetrable substrate 22 may define a mould cavity 24 (FIG. 3) to receive the uncured silicone elastomer 10 that is extruded from the extrusion head 14.

In embodiments utilizing an impenetrable substrate 22 to support the uncured silicone elastomer 10 while it is exposed to UV radiation and cured, the impenetrable substrate may be heated, as required, to assist in accelerating the curing process, Any such heat may be provided in addition or as an alternative to pre-heating prior to extrusion or in addition or as an alternative to heating following extrusion with heated lamps and/or heated plates, as outlined above.

While the embodiments described above with reference to FIGS. 1-3 involve the use of an uncured silicone elastomer requiring UV radiation to trigger curing, it is envisaged that other uncured silicone elastomers may be used.

For example, in circumstances where the uncured silicone elastomer is in a multi-part form, curing of the uncured silicone elastomer may be triggered by mixing of the respective mixable parts immediately prior to extrusion of the uncured silicone elastomer. In such embodiments, pre-heating of the respective mixable parts could be performed to increase the rate of curing of the silicone elastomer on mixing of the respective parts.

In other embodiments curing of the uncured silicone elastomer may be triggered by heating the uncured silicone elastomer to a specific temperature. In such embodiments, heating of the uncured silicone elastomer to the trigger temperature may occur during or after extrusion of the uncured silicone elastomer.

In embodiments where curing of the uncured silicone elastomer is triggered by heating the uncured silicone to a specific temperature it is of course important that any pre-heating is limited to ensure that curing of the silicone elastomer is not initiated before the silicone elastomer is extruded.

In yet further embodiments a trigger may not be required to initiate curing of the silicone elastomer. In such embodiments the shelf-life of the uncured silicone elastomer is such that the uncured silicone elastomer does not cure before it is extruded.

In such embodiments, the rate of curing of the uncured silicone elastomer may be accelerated following extrusion through the application of heat.

Apparatus 26 for manufacturing a stretchable filament of silicone elastomer according to an embodiment of the invention is illustrate schematically in FIG. 4.

The apparatus 26 includes an extrusion head 28 and a darkened supply passage 30 for supplying an uncured silicone elastomer 32 requiring UV radiation to trigger curing to the extrusion head 28. The apparatus 26 also includes a UV light source 34 to irradiate the uncured silicone elastomer 32 following extrusion from the extrusion head 28.

The provision of the darkened supply passage 30 prevents the uncured silicone elastomer 32 being irradiated with UV radiation prior to its extrusion. This in turn ensures that the silicone elastomer 32 does not cure within the supply passage 30 or the extrusion head 28, which could otherwise cause a blockage.

The apparatus 26 also includes a heat source 36 upstream of the extrusion head 28 to heat the uncured silicone elastomer 32 before it is extruded from the extrusion head 28 and a heat source 38 downstream of the extrusion head 28 to heat the silicone elastomer 32 during curing.

In other embodiments, the darkened supply passage 30 may include a plurality of tubes, each tube carrying one of a plurality of mixable parts of the uncured silicone elastomer 32. The darkened supply passage 30 may also include a controller to control the amounts of the respective mixable parts that are mixed together prior or during extrusion of the uncured silicone elastomer 32.

In the embodiment shown in FIG. 4, an impenetrable substrate 40 is provided below the outlet of the extrusion head 28 on which the uncured silicone elastomer 32 is received following extrusion.

The impenetrable substrate 40 preferably moves relative to the extrusion head 28 to allow a length of uncured silicone elastomer 32 to be laid onto the substrate 40. This may be achieved through use of a movable conveyor arrangement but it is envisaged that other movable surface arrangements may be used.

In other embodiments the relative movement may be reversed and the extrusion head 28 may be arranged to traverse a fixed substrate 40.

In such embodiments, the cross-sectional size of the length of uncured silicone elastomer 32 extruded onto the impenetrable substrate 40 may be controlled by controlling the rate of relative movement between the extrusion head 28 and the substrate 40 together with the rate of extrusion of the uncured silicone elastomer 32 from the extrusion head 28.

The impenetrable substrate 40 is formed from a material into which the uncured silicone elastomer 32 is unable to penetrate such that following curing of the silicone elastomer 32 it is possible to peel the resultant filament from the substrate 40 without tearing or ripping of the filament.

In order to further control the cross-sectional shape of the resultant filament, the impenetrable substrate 40 may define a mould cavity (not shown) into which the uncured silicone elastomer is extruded.

In order to yet further control the cross-sectional shape of the resultant filament, one or more air jets (not shown) may be directed at the uncured silicone elastomer 32 before curing is completed, the or each air jet serving to influence the final cross-sectional shape of the solid filament.

While the apparatus described with reference to FIG. 4 has been described with reference to the use of an impenetrable substrate 40 onto which the uncured silicone elastomer 32 is extruded, it is envisaged that the same apparatus could be used to create solid filaments of silicone elastomer under the influence of gravity.

In such embodiments, the impenetrable substrate 40 is removed and instead, following extrusion of a strand of uncured silicone elastomer, the strand of uncured silicone elastomer is exposed to UV radiation whilst hanging from the extrusion head 28 under the influence of gravity.

The relative arrangements of the UV light source 34 and optional heat source 38 are altered to direct UV radiation and optionally heat to the hanging strand accordingly.

In such embodiments it is envisaged that the apparatus may optionally include one or more air jets downstream of the extrusion head 28 to increase the rate of flow of the uncured silicone elastomer and thereby reduce the cross-sectional area of the eventual solid filament of silicone elastomer following curing or to create sections in the eventual filament having a smaller cross-sectional area than areas immediately adjacent thereto.

In arrangements of the apparatus where strands of uncured silicone elastomer are cured or allowed to cure under the influence of gravity, it is envisaged that multiple strands can be produced simultaneously from adjacent extrusion heads 28. In such embodiments, the strands may be intermingled during the curing process so that the individual strands become intertwined and adhere to each other to produce multi-filament yarns. In such embodiments, one or more air jets may be provided to encourage intermingling of the individual strands.

1. A method of manufacturing a stretchable filament of silicone elastomer comprising the steps of:
extruding a length of uncured silicone elastomer requiring UV radiation to trigger curing thereof; and
curing the uncured silicone elastomer or allowing the uncured silicone elastomer to cure to form a solid filament.

2. A method of manufacturing a stretchable filament of silicone elastomer according to claim 1 wherein the uncured silicone elastomer requires a trigger to initiate curing.

3. A method of manufacturing a stretchable filament of silicone elastomer according to claim 2 wherein the uncured silicone elastomer must be heated to a predetermined temperature to initiate curing.

4. A method of manufacturing a stretchable filament of silicone elastomer according to claim 2 wherein the uncured silicone elastomer is in multi-part form and curing of the uncured silicone elastomer is triggered by mixing of the respective mixable parts prior to, or during, extrusion of the uncured silicone elastomer.

5. A method of manufacturing a stretchable filament of silicone elastomer according to claim 1 further including the step of heating the uncured silicone elastomer or mixable parts of the uncured silicone elastomer prior to extrusion of the uncured silicone elastomer.

6. A method of manufacturing a stretchable filament of silicone elastomer according to claim 1 wherein the uncured silicone elastomer is heated during curing of the uncured silicone elastomer.

7-9. (canceled)

10. A method of manufacturing a stretchable filament of silicone elastomer according to claim 1 wherein the uncured silicone elastomer is constituted from two or more mixable parts.

11-16. (canceled)

17. A method of manufacturing a stretchable filament of silicone elastomer according to claim 1 wherein the uncured silicone elastomer is extruded onto an impenetrable substrate and the method further includes the step of removing the silicone elastomer from the substrate following the step of curing the uncured silicone elastomer to form a solid filament.

18. (canceled)

19. A method of manufacturing a stretchable filament of silicone elastomer according to claim 1 wherein a plurality of strands of uncured silicone elastomer are intertwined during curing to create a multi-filament yarn following curing.

20. (canceled)

21. A method of manufacturing a stretchable textile article comprising the step of weaving or knitting stretchable filaments of silicone elastomer manufactured in accordance with the method of claim 1.

22. An apparatus for manufacturing a stretchable filament of silicone elastomer in the form of an elastomer requiring UV radiation to trigger curing thereof comprising:
an applicator to extrude a length of uncured silicone elastomer, the applicator including a darkened supply passage to prevent irradiation of the uncured silicone elastomer to UV radiation prior to extrusion of the uncured silicone elastomer; and
a UV light source to irradiate the uncured silicone elastomer following extrusion of the uncured silicone elastomer to trigger curing of the uncured silicone elastomer.

23. An apparatus for manufacturing a stretchable filament of silicone elastomer in the form of an elastomer requiring UV radiation to trigger curing thereof according to claim 22 further including one or more heat sources to heat the uncured silicone elastomer either upstream, downstream, or upstream and downstream of the applicator.

24. (canceled)

25. An apparatus for manufacturing a stretchable filament of silicone elastomer in the form of an elastomer requiring UV radiation to trigger curing thereof according to claim 22 further including an impenetrable substrate onto which the uncured silicone elastomer is extruded.

26. (canceled)

27. An apparatus for manufacturing a stretchable filament of silicone elastomer in the form of an elastomer requiring UV radiation to trigger curing thereof according to claim 22 further including one or more air jets located downstream of the applicator.

28. (canceled)

29. A textile article incorporating yarns of silicone elastomer wherein the article is a knit or woven article.

30. A textile article according to claim 29 wherein the knit or weave of the textile article is chosen to expose the yarns of silicone elastomer on an outer surface of the textile article.

31. A textile article according to claim 30 wherein the textile article is a garment and the yarns of silicone elastomer are exposed on an inner surface of the garment intended to be worn against a wearer's skin.

32-33. (canceled)
